(19) United States
(12) Patent Application Publication
(10) Pub. No.: US 2005/0157504 A1
(43) Pub. Date: Jul. 21, 2005

(54) Luminaire reflector

(76) Inventor: James G. Vanden Eynden, Hamilton, OH (US)

Correspondence Address: HASSE & NESBITT LLC, 7550 CENTRAL PARK BLVD., MASON, OH, 45040, US

(21) Appl. No.: 11/076,717

(22) Filed: Mar. 10, 2005

Related U.S. Application Data
(63) Continuation-in-part of application No. 10/660,317, filed on Sep. 11, 2003.

(51) Int. Cl. F21V 7/00

(52) U.S. Cl. 362/346

(57) ABSTRACT

A reflector element, and a reflector assembly for use in an electrically-powered luminaire that has a plurality of the spaced-apart reflector elements. The light emitted from a lamp within the luminaire is reflected by the reflector elements away from the lamp and through openings between adjacent reflector elements. The reflector element has a plurality of reflector panels arranged in a plurality of rows and columns. The shape of the reflector element is parabolic through a vertical section of the element, to reflect the light vertically through the openings and from the luminaire at the same angle. The shape of the reflector element is elliptical through a horizontal section of the element, to reflect the light horizontally through the openings and from each individual panel at the same angle of reflectance, to evenly distribute the horizontally reflected light. The use of the improved reflector elements in the luminaire results in an increased light distribution pattern and improved energy and operational efficiency.

### CROSS-REFERENCE TO RELATED APPLICATION

This is a continuation-in-part application, claiming the priority of co-pending U.S. patent application Ser. No. 10/660,317, filed Sep. 11, 2003.

### FIELD OF THE INVENTION

This invention relates generally to luminaire reflectors and more particularly to luminaire reflectors used for a wide variety of lighting applications.

### BACKGROUND OF THE INVENTION

Many luminaires incorporate reflectors to increase the efficiency of their light output. Reflectors can be formed in a variety of shapes and sizes and are typically designed and oriented to provide optimized light distribution for particular applications. Accordingly, they may be symmetrical or asymmetrical depending on the desired light output distribution. The most common reflector for a luminaire is a symmetrical reflector. Because the reflector surrounds the lamp to reflect the light, it is usually fashioned from a single piece of material or is fashioned from multiple pieces of material to constitute a single reflector.

As mentioned, a standard reflector for a luminaire is a symmetrical design. The reflector surrounds the lamp and reflects the light downward in a substantially round distribution pattern. Because the lamp is almost always placed within the volume defined by the reflector, the wide angle illumination of a lamp and reflector combination is limited to the light that is directly emitted from the lamp and/or is reflected by the reflector and then passes below the edge of the reflector or luminaire body without contacting any part of the luminaire. This limitation results in a relatively limited wide angle light distribution pattern below the luminaire. To an extent, this difficulty can be addressed by lowering the lamp within the reflector volume or raising the reflector with respect to the lamp. However, this can result in increased glare and eye strain. Additionally, in having a reflector that surrounds the lamp some of the light is reflected multiple times within the reflector thereby reducing the efficiency of the luminaire. Further, some of the light is reflected back through the lamp itself that can result in reduced lamp life and reduced efficiency.

While other reflectors have been designed specifically to provide wide angle lighting distribution patterns, they are subject to different design considerations and usually result in decreased light intensity in certain regions in order to maximize the light intensity in other desired areas. While this provides an improved luminaire for specific lighting applications, such luminaires have limited utility for other lighting applications.

Thus, there is a substantial need for a reflector that can increase luminaire efficiency while providing increased wide angle lighting.

### SUMMARY OF THE INVENTION

The present invention relates to a reflector assembly, and its use in a luminaire having a light source securable therein, the reflector assembly comprising a plurality of positioned reflector elements for reflecting light emitted from the light source, the reflector elements being disposed radially and spaced apart around the light source in a horizontal plane to provide an opening between adjacent reflector elements, wherein each reflector element is configured and positioned to reflect light emitted by the light source away from the light source and through the adjacent opening.

The present invention also relates to a reflector element for use in a luminaire, comprising a plurality of reflector panels. Typically, the reflector element has a curved shape having a cross section in a first orientation that is elliptical, and a cross-section in a second orientation perpendicular to the first orientation that is parabolic.

The present invention further relates to a luminaire comprising: at least one lamp that provides a light source; a lamp socket for each of the lamps, wherein each of the lamp sockets is sized to receive the base of the lamp, the lamp sockets being electrically connected to a power source and having an electrical contact and being electrically connectable to the bases of the lamps; a plurality of reflector elements fixedly disposed radially from and spaced apart around the lamp in a horizontal plane to provide an opening between adjacent reflector elements, wherein light that is emitted from the light source is reflected by the reflector elements through the adjacent openings.

The present invention provides increased wide angle lighting over standard and specialized luminaires. The individual reflector elements do not physically enclose the light source, typically a lamp, but are disposed spaced-apart around the lamp, to provide openings between adjacent reflector elements through which the horizontally and vertically downward reflected light can pass to the outside of the luminaire. More specifically, the reflector elements are of such shape, location and orientation that substantially none of the light emitted from the lamp is reflected by any reflector element back toward the light source of the luminaire, and whereby substantially none of the light reflected from an inner surface of a reflector element is reflected back toward an inner surface of any other reflector element of the reflector assembly. Instead, the reflector elements are configured to reflect substantially all of the light emitted from the lamp away, and typically horizontally and vertically downward, from the lamp. The reflected light can exit the luminaire in a controlled manner with as little interference by the lamp and other reflector surfaces, thereby creating a highly energy efficient luminaire.

### BRIEF DESCRIPTION OF THE DRAWINGS

FIG. 1 is a perspective view of an embodiment of the present invention, showing a reflector assembly consisting of four reflector elements, with one of the reflector elements partially cut away to show a lamp.

FIG. 2 is an elevation view of the reflector assembly of FIG. 1.

FIG. 3 is a plan view of the reflector assembly, as viewed from line 3-3 of FIG. 2.

FIG. 4 is a perspective view of a luminaire of the present invention, showing a reflector assembly and a lamp and a surrounding lens.

FIG. 5 is an elevated view of the luminaire of FIG. 4, as viewed from line 5-5 of FIG. 4.

FIG. 6 is a simplified plan view of a luminaire of the present invention, showing the light reflection pattern for selected light beams emitted from the light source and reflecting from the panels of one of the reflector elements.

FIG. 7 is a light reflection pattern similar to FIG. 6, showing more of the light beams emitted from the light source and reflecting from the panels of the reflector element.

FIG. 8 is a diagram showing the light distribution pattern for a typical luminaire embodiment of the present invention.

FIG. 9 is a perspective view of a single reflector element or blade of the present invention.

FIG. 10 shows three horizontal curve profiles X1, X2 and X3, corresponding to selected cross-sections of the reflector blade of FIG. 9, taken along lines X1-X1, X2-X2, and X3-X3, respectively, and shows three vertical curve profiles Y1, Y2 and Y3, corresponding to selected cross-sections of the reflector blade of FIG. 9, taken along lines Y1-Y1, Y2-Y2, and Y3-Y3, respectively.

FIG. 11 shows a partial perspective view of two of the reflector panels of the assembly shown in FIG. 1, and a light source.

FIG. 12 shows a sectional elevation view of a prior art reflector.

FIG. 13 also shows a sectional elevation view of a prior art reflector.

### DETAILED DESCRIPTION OF THE INVENTION

Typically the reflector elements are positioned within the luminaire in the area generally adjacent to the lowest light emitting point of the light source, that is, opposite the socket end of the lamp, and continuing to the area generally adjacent to the highest light emitting point, typically proximate the socket end of the light source or lamp. In a typical embodiment, the luminaire has a plurality of reflector elements, including two elements, three elements, four elements, five elements, or more. The reflector elements are typically identically configured and oriented, and are typically, though not necessarily, equally spaced radially from the light source, and from adjacent elements.

A more typical luminaire has four identically-configured reflector elements symmetrically disposed around a centrally-positioned lamp. Each of the reflector elements is arranged radially in ninety degree increments around the lamp. The vertical cross-sections of the reflectors are curves and are shaped so that substantially all of the emitted light from the lamp that strikes at any portion of the reflector element is reflected at substantially the same angle, typically a downward angle, from the luminaire. Accordingly, the light that is emitted from the lamp but not reflected by the reflector elements illuminates a first area below the luminaire, while the reflected light illuminates, typically solely illuminates, areas lying outside the first area, according to the designated angle. Together, the illumination patterns are designed to create a substantially round pattern. The downward angle of reflection of light from the luminaire is up to about seventy degrees from nadir, thereby cutting off further wide angle illumination to prevent glare and eye strain and reducing the number of poles and fixtures otherwise required.

In general, the reflector element is disposed in the assembly or in the luminaire so that the reflector surface is non-perpendicular to the light source. The reflector element has a leading edge that is typically disposed further away from the light source than its trailing edge, so that the surface therebetween faces away from the light source. Where the light source is disposed in the center of the luminaire, the leading edge of the reflector elements are typically angled outward from the circle formed by the trailing edges of the elements. The angling of the reflector elements aids the function of the reflector surface to reflect the emitted light away from the light source and through the adjacent opening between the reflector element and its succeeding element neighbor.

In a typical embodiment, the reflector element is comprised of a resilient, reflective material that can have an overall curved shape that is generally parabolic along a vertical plane passing through the reflective element, and is generally elliptical along a horizontal plane passing through the reflective element. Alternatively, the reflector element can have an overall curved shape that is generally elliptical in the vertical plane passing through the reflective element, and generally parabolic in the horizontal plane passing through the reflective element, or can have a shape that is elliptical in both the vertical and horizontal cross sections, or that is parabolic in both the vertical and horizontal cross sections. The effect on the distribution of the reflected light from a parabolic or elliptical reflective surface will be discussed hereinafter.

A typical parabolic surface can be viewed as a plurality of columns of a reflective material, the columns arranged vertically and side-by-side, with each column having a parabolic shape. Typically the columns of reflective material will comprise a plurality of reflective panels arranged linearly, and typically each panel is planar. Light emitted from the light source will strike each of the plurality of panels in a column at an angle of incidence relative, and will be reflected from the respective panels at an equal angle of reflectance, relative to the panel. The column of panels arranged into a parabolic surface can provide that the angle of incidence and the angle of reflectance from one panel to the next panel are different, but that the angle of reflectance of the light relative to the light source is the same. Therefore, light reflected from a parabolic surface will typically reflect out from the luminaire at generally the same angle, relative to the light source and the luminaire, but reflect from the panels along the parabolic surface at different angles of reflectance.

A typical elliptical surface can be viewed as a plurality of rows of a reflective material, the rows arranged horizontally and side-by-side, with each row having an elliptical shape. Typically the rows of reflective material will comprise a plurality of reflective panels arranged linearly, and typically each panel is planar. Light emitted from the light source will strike each of the plurality of panels in a row at an angle of incidence relative, and will be reflected from the respective panels at an equal angle of reflectance, relative to the panel. The row of panels arranged into an elliptic surface can provide that the angle of incidence and the angle of reflectance of all the panels are all the same, but that the angle of reflectance of the light relative to the light source is different. Therefore, light reflected from an elliptic surface will typically reflect out from the luminaire at different angles, but will reflect from the panels along the elliptic surface at generally the same angle of reflectance.

Thus, the shape of the reflector elements can be adjusted or changed to alter the angle at which the emitted light from the lamp is reflected. The reflector elements could also be asymmetrically disposed around the lamp to create a non-uniform illumination pattern. Also, if desired, a lens can be used beneath and/or around the lamp and reflector elements to focus the emitted light and/or to protect the lamp and reflector elements.

Typically, the reflector elements are comprised of a plurality of reflector panels formed integrally into the material of the reflector element. The plurality of reflector panels are more typically planar, but can themselves have non-planar surfaces. The reflector panels can be sized the same or different, and can typically range from about 3 cm or less. The plurality of panels can have any shape, typically square or rectangular, but can also be hexagonal, round, or other, and can be the same shape or of different shape. The plurality of panels can also be arranged in any pattern, such as rows and columns, or in a hexagonal or pentagonal pattern, or the like. The selection of the size, shape and pattern of the panels is typically a design selection, criteria for which include ease of design and manufacture, and efficiency and effectiveness of the reflected light. In a more typical design, the reflector elements are rectilinear, and arranged in rows and columns.

In a typical embodiment, a high wattage (e.g., 400 watt) metal halide high intensity discharge (HID) lamp is used, although other types of lamps with varied shapes and with different lumen output could be substituted in its place for different applications. For HID lamps, external control equipment is commonly used and is stored within a ballast box located within the luminaire or remotely mounted, and electrically connected to the luminaire.

The reflector elements can be formed by a variety of methods used to form reflectors including but not limited to using a sheet metal hydroform press, a plastic injection molding and vapor deposition process, a die cast for zinc or rapid tooling technologies.

The reflector elements provide a luminaire with increased angle illumination, to reduce the number of luminaires required to illuminate an outdoor (or indoor) area. Additionally, the design of the reflector elements provides increased energy efficiency over a standard luminaire as the result of the minimized internal reflections, thereby providing greater illumination and permitting the use of lower wattage lamps for equivalent levels of light. This reduces electricity usage while preserving usable light output.

The luminaire of the present invention is particularly useful for reflecting the emitted light vertically (downwardly) outward and away from the location of the luminaire (that is, in a wide angle from nadir). The angle of the light reflected from the luminaire in a vertical direction is typically up to about 90°, more typically up to about 70°, from nadir.

Typically the light is reflected from the reflector elements in a horizontal direction through the openings and out from the luminaire in a substantially uniform, circular or rectangular pattern. Alternatively, the reflected light can be focused or concentrated by one or more of the reflector elements in one or more specific directions.

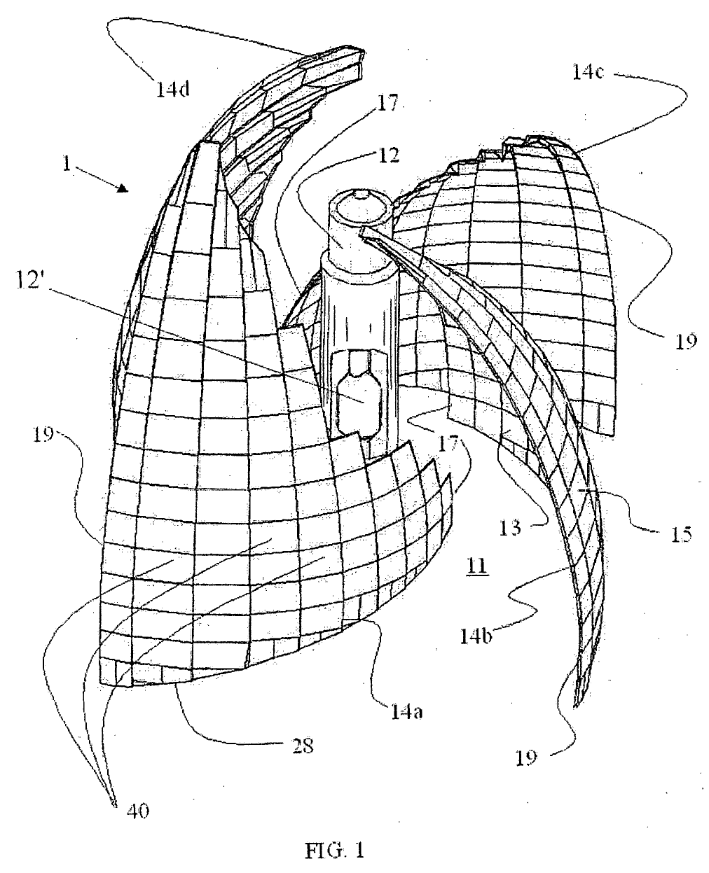

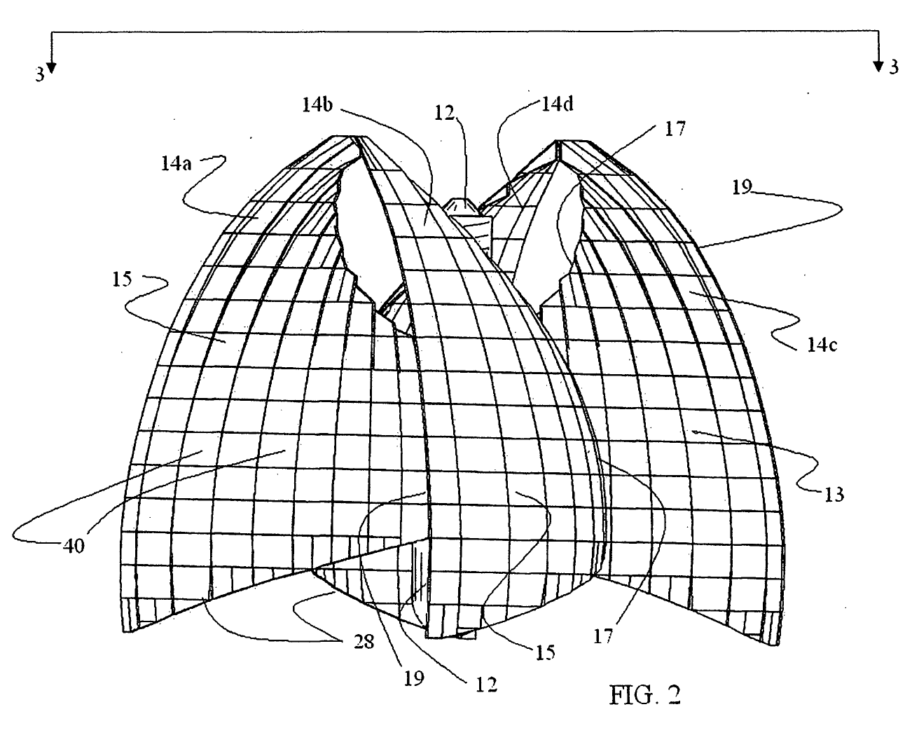

A reflector assembly 1 of the present invention for use in a luminaire is shown in FIGS. 1, 2 and 3, and comprises four reflector elements 14 that surround a lamp 12. In the illustrated embodiment, the lamp 12 comprises of light source 12′, typically an arc tube of a high intensity discharge (HID) lamp. Some of the panels 40 above the trailing edge 17 of the front reflector element 14a of FIG. 1 have been removed to better view the lamp 12 with light source 12′. The four reflector elements 14 are typically identical in size and shape, and are shown as separate blade elements that have a curved shape. In the illustrated embodiment, the shape of the reflector element is generally parabolic in a vertical plane passing through the reflective element, and generally elliptical in the horizontal plane passing through the reflective element. The reflector elements 14 are symmetrically oriented around the lamp 12 such that all of the light output that strikes the inner surface 13 of the reflector elements 14 (and that is not initially directed below the bottom edges 28 of the reflector elements 14) is reflected from the inner surface 13 through the openings 11 formed between the adjacent reflector elements 14a, 14b, 14c and 14d. Alternatively, some reflected light can be reflected from the inner surface 13 off of the back surface 15 of the adjacent reflector element and outward.

Each reflector element 14 can be comprised of a plurality of reflecting panels 40. The reflecting panels 40 are illustrated as rectangular or square in shape. The reflector panels 40 are formed integrally into a single piece of reflective material. The edges of the reflecting panels 40 are arranged side by side, typically in rows and columns, and form a continuous reflector surface. The plurality of reflecting panels 40 are configured whereby substantially all of the light emitted from the lamp that strikes the inner surface 13 of a particular reflecting panel 40 will reflect through the opening 11 at generally a single, specific angle. Typically, each reflecting panel 40 is configured and oriented in space slightly differently from its adjacent reflecting panels and each typically has a planar shape, or a substantially planar shape.

While FIG. 1, for example, shows clearly the edges between adjacent planar reflecting panels 40, the reflecting panels 40 can be configured to provide a curved joint between adjacent panels 40, that make the joint lines less apparent and can give the reflector element 14 the appearance of having a smoother surface.

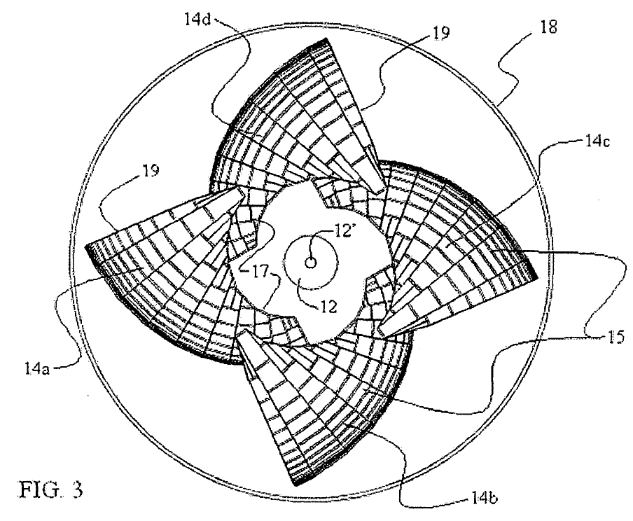

The illustrated reflector element 14 in FIG. 3 is shown generally to have about 10 columns and 12-15 rows of the panels 40. The reflector panels can have a maximum horizontal dimension of about 3 cm or less, and typically a maximum vertical dimension of about 1 cm or less. It can be understood that each individual reflector panel 40 can be configured with either a larger dimension though more typically a much smaller dimension, which in turn will increase the number of reflector panels in each row and column.

In a typical embodiment of a luminaire, the dimensions of the reflector assembly, from the furthest outside point along the leading edge 19 of a first reflector element to the furthest outside point along the leading edge 19 of the reflector element that is opposite the first reflector element, is about fifteen inches (about 38 cm) and the height of each reflector element is about eleven inches (about 28 cm).

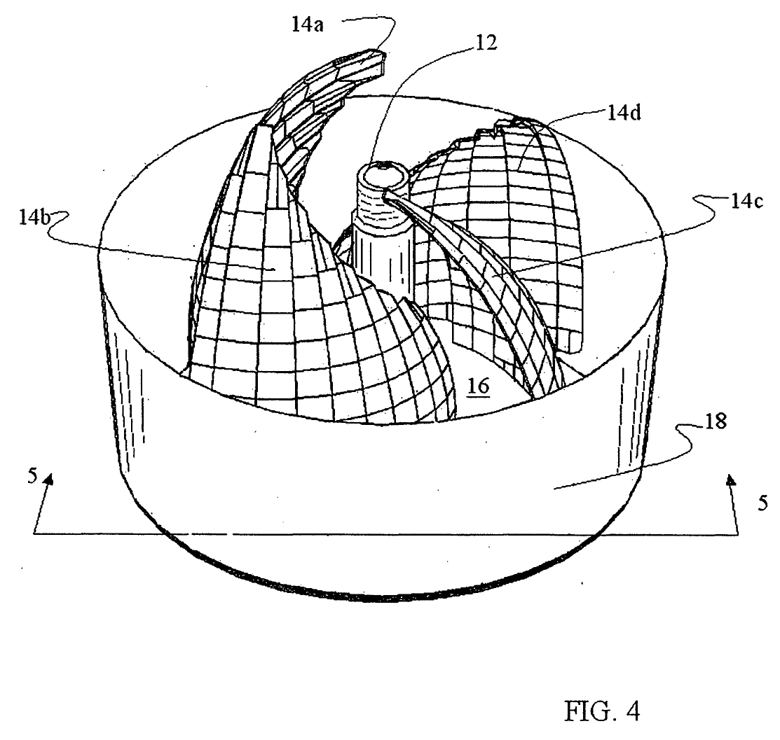

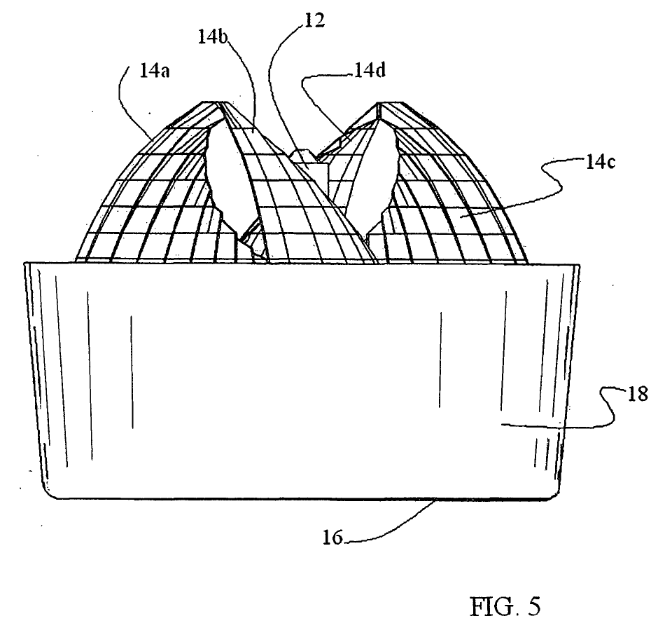

The reflector elements 14 can be secured in position to form a reflector assembly by a variety of methods. FIGS. 4 and 5 show the reflector elements 14a, 14b, 14c and 14d being held in place by placement on top of a bottom lens 16, in a position where the plurality of reflectors are centered around lamp 12 inside of a peripheral lens, or a luminaire body, 18. Examples of other methods by which the reflector elements could be held in place as a reflector assembly include: joining them to an overhead frame via a conventional fastening means; attaching them to a frame via fastening means, attaching them directly to the lens with adhesive means, using wire form rings attached to an overhead frame, using a single wire form ring on a neutral axis of the reflectors or other fastening means.

The basic shape and special orientation of the individual reflecting panels in the reflector elements is accomplished through a well known technique called ray-tracing, which is illustrated by William B. Elmer, “The Optical Design of Reflectors”, Second Edition; ISBN 0-471-05310-4, incorporated herein by reference. While these calculations can be done manually, it is highly preferred to automate the calculations with the use of computers and appropriate software. These reflecting panels are then connected/assembled into a three dimensional wire frame computer model. This model is then analyzed for desired output using software openly available on the market. After the desired shapes of the individual reflecting panels 40, and of the reflector element 14, have been achieved, the wire frame model is converted into a solid model that gives the reflector element volume and mass. The solid model can then be sent to various injection molding/die casting vendors who can use the geometry created by the solid model to directly program cutting tools for the production of molds/tools for full scale production. The reflector components can be finished in a secondary operation through vacuum metalizing, polishing or anodizing to achieve a highly specular surface.

The reflector elements 14 are positioned within the reflector assembly such that a leading edge 19 is disposed farther away from the light source than the trailing edge 17, typically the leading edge 19 of a reflector element overlaps with the trailing edge 17 of the adjacent reflector element 14, such that any light that is emitted outward is reflected by one of the reflector elements 14. When the reflector elements are arranged symmetrically, each reflector element 14 will span a radial arc of at least X degrees relative to the light source 12′ according to equation (1) where
X≧360/n (1)
and n is the number of symmetrically disposed reflector elements in the reflector assembly of the luminaire. As shown in FIGS. 1 and 3, the reflector elements assume the shape and appearance of a pinwheel or the cross section through a nautilus mollusk.

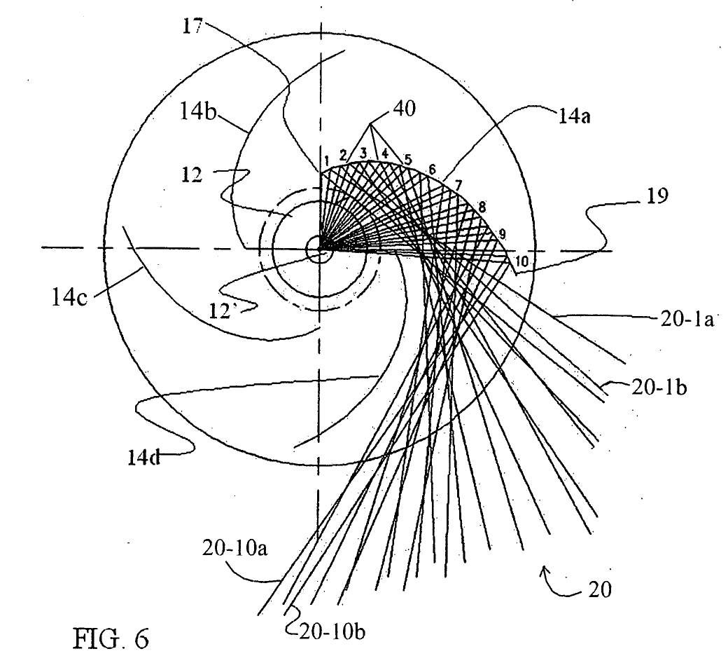

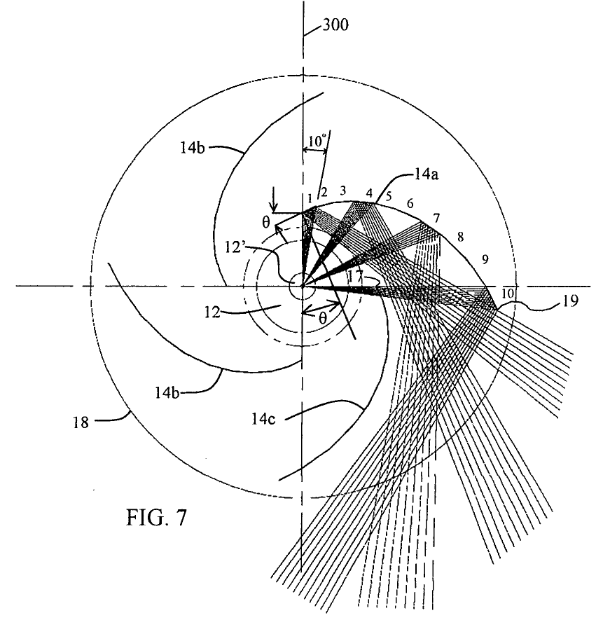

The light reflection pattern of reflected light rays 20 of a typically reflector assembly of the present invention is depicted in FIGS. 6 and 7. FIG. 6 shows a plan view of a reflector assembly having a first reflector element 14a and a second reflector element 14d. FIG. 6 shows how a selected number of light beams emitted from the light source point 12′ of lamp 12 are reflected in a direction away from the light source 12′ by the first reflector element 14a to form a light reflection pattern 20. In the illustrated embodiment, the plurality of reflecting panels 40, positioned end to end along a particular horizontal plane of the reflector element 14a and proceeding from the trailing edge 17 to the leading edge 19, are numbered #1, #2, #3, #4, #5, #6, #7, #8, #9, and #10. The light rays 20-1a and 20-1b reflected from the leading and trailing portions of reflecting panel #1 (positioned near the inner end 17 of the first reflector element 14a) pass near the outer end 19 of the reflector element 14a. Light rays 20-10a and 20-10b reflected by reflecting panel #10 pass near the back 15 (and behind) the second reflector element 14d. However, substantially none of the reflected light is reflected again by either the first reflector element 14a or the second reflector element 14d. FIG. 6 also illustrates how light rays that reflect from adjacent panels 40 can overlap, to help blend the emitted light from the reflector.

FIG. 7 shows the same light reflection pattern of light rays 20 as in FIG. 6, but with more of the light beams shown on only particular reflector panels namely, #1, #4, #7 and #10. FIG. 7 better illustrates that substantially all of the light that is emitted by the light source onto the entire surface of a specific reflecting panel (e.g., panel #1, #4, etc.) is reflected at substantially the same angle. The first planar panel #1 is shown positioned at an angle θ from a plane that is normal to the emitted light along vertical centerline 300. The incident angle of the emitted that strikes the trailing end of the first panel #1 is also angle θ. It can be shown that each panel 40 along the horizontal length of the reflector element 14 covers a sector of about 10°, so that in the illustrated embodiment, the emitted light strikes the leading end of the first panel #1 at an angle of about θ+10°. In the illustrated embodiment, the angle θ is about 25-26°, and preferably 25.5°. Consequently, the angle of reflectance of the light reflected from the first panel #1 is from about 25° to about 35°. Likewise, the angle of reflectance of the light that is reflected from the remaining panels 40 in the row of panels is about 25° to about 35°. This provides for horizontal scattering of the light reflected from the luminaire in over the entire quadrant of area illuminated by that reflector element.

FIG. 7 also illustrates how the reflected light from the reflector element 14a passes along the back or outer surface 15 of the adjacent reflector element 14d. It also shows that emitted light that passes over the trailing edge 17 of reflector panel 14d strikes the panels at the leading edge 19 of reflector element 14a.

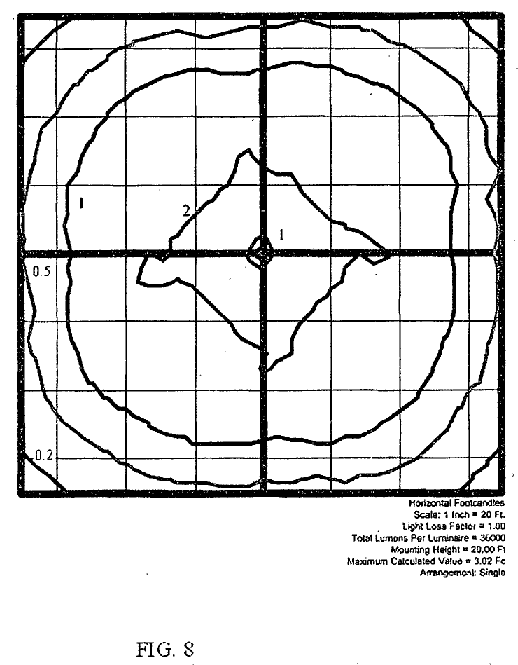

A photometric report for the preferred reflector assembly and luminaire of the present invention is shown in FIG. 8. In this particular report, a single luminaire was mounted at a height of twenty feet. The report shows the horizontal illumination of the luminaire on the ground below in footcandles (FC). Each vertical and horizontal gradation, originally 1 inch (2.54 cm) in length, represents 20 feet (6.1 meters). Other conditions of the photometric test were: light loss factor=1; and total lumens per luminaire=36,000. The maximum calculated value was 3.02 FC. Qualitatively, the illustrated embodiment of the luminaire produces a widespread, substantially round light pattern. The light intensity distribution could easily be modified by adjusting the shape, size, position and/or number of the reflector elements 14 and their plurality of reflecting panels 40.

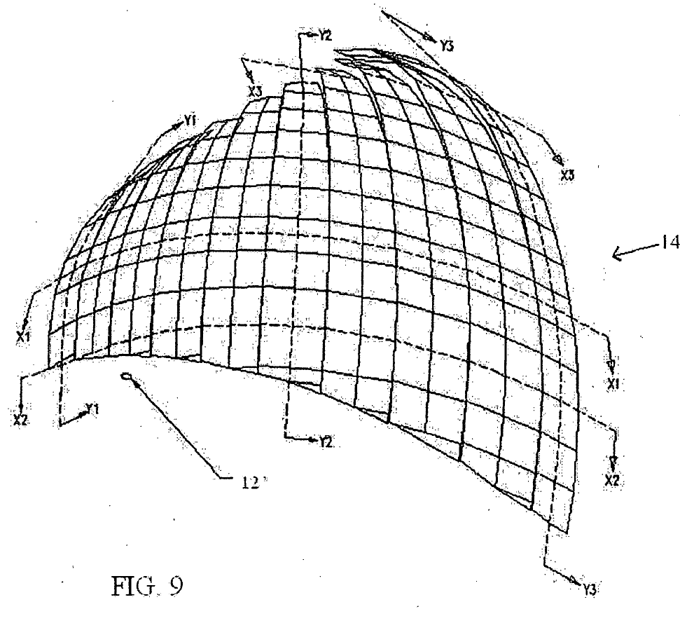

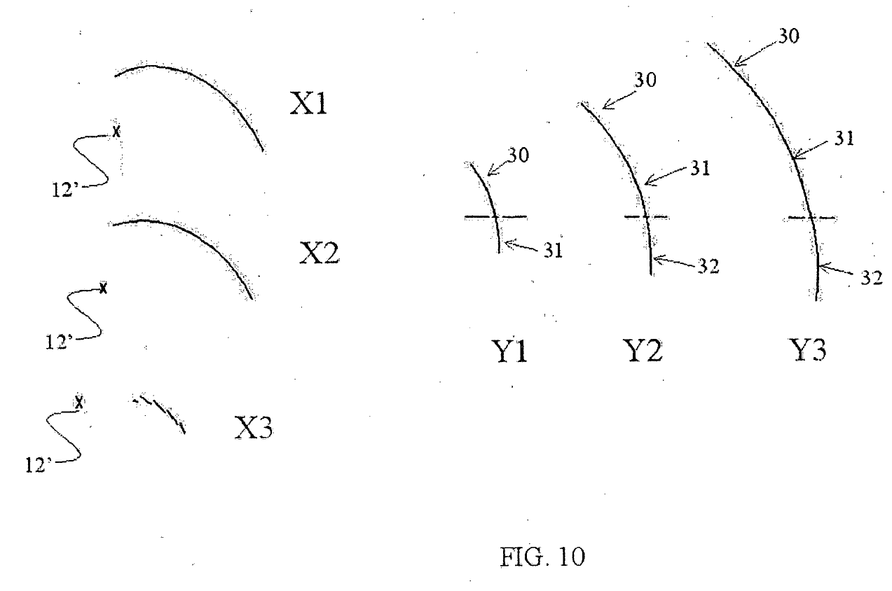

FIG. 9 shows a single reflector element 14 of the present invention. A plurality of horizontal (X) and vertical (Y) section lines are taken through the curved surface of the reflector element, as illustrated in FIG. 10. The lamp is represented as a single point and referred to as the light center 12′. FIG. 10 shows the individual curves X1, X2 and X3, taken along horizontal section lines X1-X1, X2-X2 and X3-X3, respectively, in curves Y1, Y2 and Y3 taken along, vertical section lines Y1-Y1, Y2-Y2 and Y3-Y3, respectively, are shown as they pass through the reflector element in FIG. 9. In a preferred embodiment, curve X2 is below curve X1, and curve X3 is above curve X1. Curves Y2 and Y3 each are comprised of three different generally parabolic shapes 30, 31 and 32, and curve Y1 is comprised of two generally parabolic segments 30 and 31.

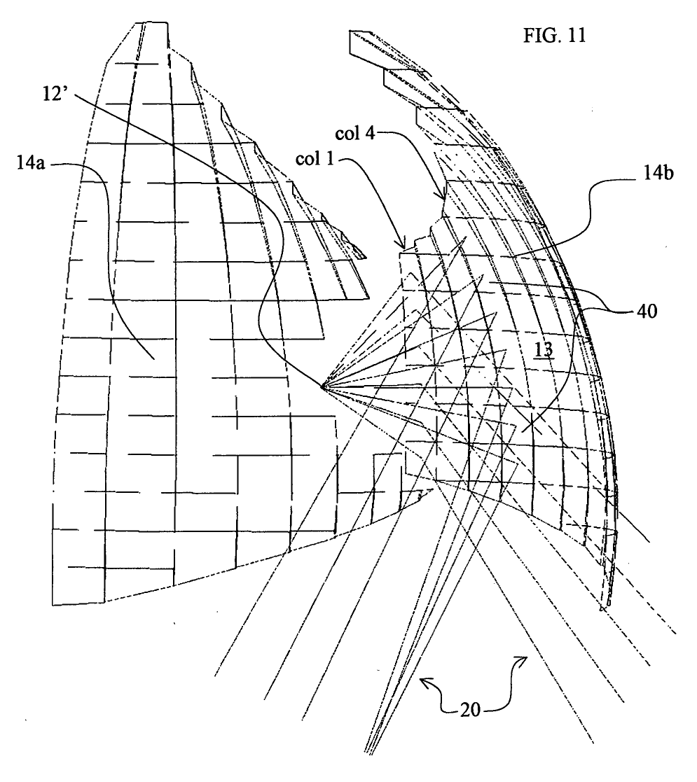

The curved horizontal and vertical surfaces of the reflector element provide the required reflection of light from the light source into the horizontal and downward direction, away from the light source. FIG. 11 shows a partial perspective view of the reflector assembly used in the luminaire, showing only reflector elements 14a and 14b, and light source 12′. Panels along the trailing edge of element 14a are removed to better view the light source 12′. Light rays are shown emitted from light source 12′ toward the inside 13 of each panel 40 in the first column and the fourth column of reflective panels in reflector element 14b. The reflected light rays 20 from each panel of columns 1 and 4 are reflected through the opening horizontally away from the light source, and downward. In the illustrated embodiment, the panels arranged in rows are in an elliptical shape, such that the angle of reflectance from each of the panels in the horizontal plane is essentially the same. The panels arranged in columns are in a parabolic shape, such that the absolute vertical angle of reflectance of all the reflected light rays from the luminaire is substantially the same, although the two-dimensional figure do not readily depict that the reflected light from the panels in column 1 are reflected from the luminaire at the same vertical angle as those light rays reflecting from the panels in column 4.

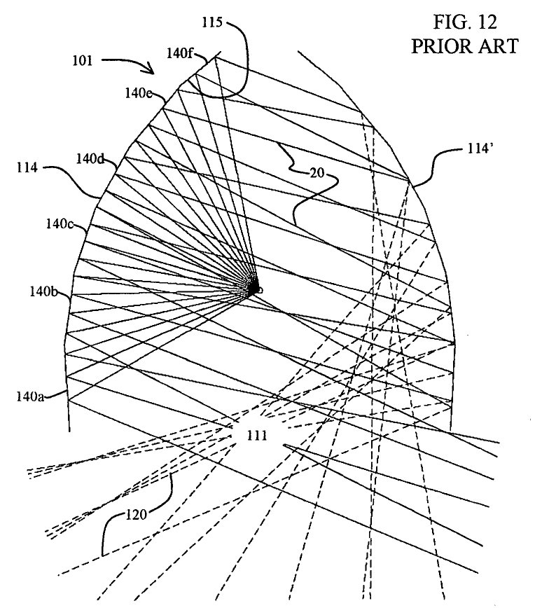

The present invention of an improved reflector luminaire proves improvements over conventional reflector luminaires, such as those illustrated as prior art in FIGS. 11 and 12.

FIG. 12 is a simplified sectional view through a prior art reflector 101 generally configured as a single unit having a curved wall 114. The wall 114 is shown comprised of discrete segments 140a-f. A light source 112′ emits rays of light. It can be seen that light rays 20 that reflect off inside surface 115 of segments 140c, 140d, 140e, and 140f are reflected into the opposite or facing wall 114′. The re-reflected light rays 120 (shown as dashed lines for clarity) may exit the luminaire. Each time light bounces off of a surface some illumination energy is lost as heat. It can also be seen that a significant amount of the reflected light 20 passes back at and through the lamp that comprises the light source 12′, which further scatters the light and reduces efficiency. Such prior art reflectors have reduced energy efficiency.

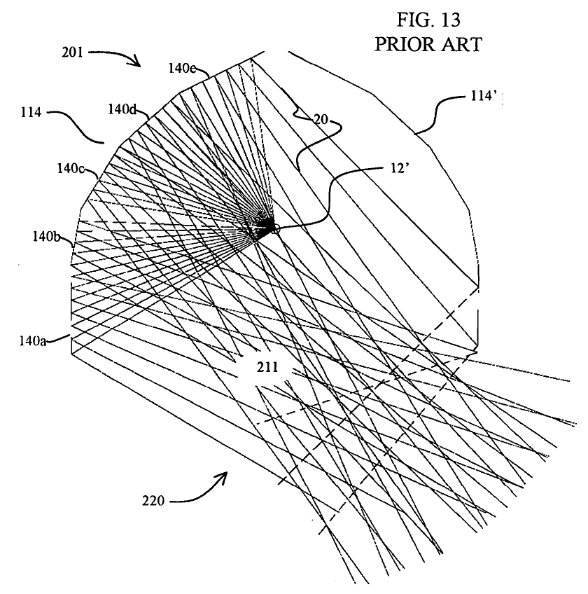

FIG. 13 is a simplified view through another prior art reflector 201 that has a different cross sectional wall 214 shape. In the reflector 201 illustrated, substantially all of the reflected light rays 220 exit the opening 211 after the first reflection, it can be seen that a majority of the reflected light rays 220 have a slight angle to nadir (that is, are directed at an acute angle to nadir more straight down then outward), and a minority of reflected light rays are reflected outward at an angle of about 45° or more from nadir. Consequently, this type of prior art reflector luminaire is energy efficient, but tends to provide only an effective amount of light downward in the vicinity below the luminaire, but provides an insufficient amount of light more distant from the luminaire. It can also be seen that a significant amount of the reflected light 220 passes back at and through the lamp that comprises the light source 12′, which further scatters the light and reduces efficiency. For lighting large floor space or outdoor areas, these lights tend to provide intense but narrowly focused lighting patterns, therefore requiring additional luminaires and increased energy to illuminate an area effectively.

In contrast, the present invention provides an improved luminaire that is energy efficient and that emits a more widespread lighting pattern by allowing the more horizontally-reflected light to pass through openings between the reflector elements, therefore reducing required luminaries and reducing energy to illuminate an area effectively.

While the present invention has been illustrated by description of embodiments that has been described in detail, to the invention as claimed in the appended claims is not restricted or in any way limited to the scope of such detail.

1. A reflector assembly for a luminaire having a light source securable therein, the reflector assembly comprising a plurality of positioned reflector elements for reflecting light emitted from the light source, the reflector elements being disposed radially and spaced apart around the light source in a horizontal plane to provide an opening between adjacent reflector elements, wherein each reflector element is configured and positioned to reflect light emitted by the light source away from the light source and through the adjacent opening.

2. The reflector element according to claim 1 wherein the reflective surface of the reflector element is non-perpendicular to the light source.

3. The reflector assembly according to claim 1 wherein the reflector element comprises a plurality of reflector panels.

4. The reflector assembly according to claim 3 wherein the reflector panels are planar.

5. The reflector assembly according to claim 1 wherein the reflector panels are arranged in a plurality of rows and a plurality of columns.

6. The reflector assembly according to claim 1 wherein the reflector elements are substantially vertically disposed.

7. The reflector assembly according to claim 1 wherein the reflector elements are in a fixed position within the assembly.

8. The reflector assembly according to claim 1 wherein each reflector element is configured and positioned to reflect the light that is emitted from the light source at the same vertical angle relative to the assembly.

9. The reflector assembly according to claim 1 wherein each reflector element is configured and positioned to reflect the light that is emitted from the light source at the same horizontal angle relative to the assembly.

10. The reflector assembly according to claim 5 wherein each of the plurality of reflector panels is configured and positioned to reflect the incident light that is emitted from the light source at the same vertical angle relative to the assembly.

11. The reflector assembly according to claim 5 wherein each of the plurality of reflector panels is configured and positioned to reflect the incident light that is emitted from the light source at the same horizontal angle of reflectance relative to the assembly.

12. The reflector assembly according to claim 5 wherein each of the plurality of reflector panels is configured and positioned to reflect the incident light that is emitted from the light source at the same horizontal angle of reflectance from the reflector panel.

13. The reflector assembly according to claim 10 wherein each of the plurality of reflector panels is configured and positioned to reflect the incident light that is emitted from the light source at the same horizontal angle of reflectance from the reflector panel.

14. The reflector assembly according to claim 5 wherein the each of the plurality of reflector panels is configured and positioned to reflect the incident light that is emitted from the light source at the same vertical angle of reflectance from the reflector panel.

15. The reflector assembly according to claim 1 wherein the reflector element has a shape that is generally parabolic along a vertical plane passing through the reflective element.

16. The reflector assembly according to claim 1 wherein the reflector element has a shape that is generally elliptical along a horizontal plane passing through the reflective element.

17. The reflector assembly according to claim 15 wherein the reflector element has a shape that is generally elliptical along a horizontal plane passing through the reflective element.

18. The reflector assembly according to claim 1 wherein the reflector element has a cross-sectional shape that is generally elliptical along a vertical plane passing through the reflective element.

19. The reflector assembly according to claim 1 wherein the reflector element has a cross-sectional shape that is generally parabolic along a horizontal plane passing through the reflective element.

20. The reflector assembly according to claim 8 wherein the vertical angle is up to approximately seventy degrees from nadir.

21. The reflector assembly according to claim 5 wherein each reflector panel has a maximum vertical dimension of about 1 cm or less, and a maximum horizontal dimension of about 3 cm or less.

22. A luminaire comprising:
at least one lamp that provides a light source;
a lamp socket for each of the lamps, wherein each of the lamp sockets is sized to receive the base of the lamp, the lamp sockets being electrically connected to a power source and having an electrical contact and being electrically connectable to the bases of the lamps;
a plurality of reflector elements fixedly disposed radially from and spaced apart around the lamp in a horizontal plane to provide an opening between adjacent reflector elements, wherein light that is emitted from the light source is reflected by the reflector elements through the adjacent openings.

23. The luminaire according to claim 22 wherein the reflector element comprises a plurality of planar reflector panels.

24. The luminaire according to claim 23 wherein the reflector panels are arranged in a plurality of rows and a plurality of columns.

25. The luminaire according to claim 22 wherein the reflector elements are substantially vertically disposed and in a fixed position within the luminaire.

26. The luminaire according to claim 22 wherein the reflector panels are configured and positioned to reflect the light that is emitted from the light source at the same vertical angle relative to the luminaire.

27. The luminaire according to claim 26 wherein the reflection angle is up to approximately seventy degrees from nadir.

28. The luminaire according to claim 22 wherein the reflector element has a shape that is generally parabolic along a vertical plane passing through the reflective element, and generally elliptical along a horizontal plane passing through the reflective element.

29. The luminaire according to claim 22 wherein the reflector elements are identical and disposed in the same orientation symmetrically around the light source.

30. The luminaire according to claim 24 wherein each of the plurality of reflector panels is configured and positioned to reflect the incident light that is emitted from the light source at the same vertical angle relative to the assembly, and at the same horizontal angle of reflectance from the reflective panel.

31. A reflector element for use in a luminaire, comprising a plurality of reflector panels, and having a curved shape having a cross section in a first orientation that is elliptical, and a cross-section in a second orientation perpendicular to the first orientation that is parabolic.

32. The reflector element according to claim 31, wherein the cross section in both orientations is parabolic.

33. The reflector element according to claim 31, wherein the cross section in both orientations is elliptical.

34. The reflector element according to claim 31, wherein the reflector panels are planar

35. The reflector element according to claim 31, wherein the reflector panels are arranged in a plurality of rows and a plurality of columns.
